(19) United States
(12) Patent Application Publication
(10) Pub. No.: US 2023/0225536 A1
(43) Pub. Date: Jul. 20, 2023

(54) FINGER RING HOLDER

(71) Applicant: Jicheng Technology (Shenzhen) Co., Ltd., Shenzhen (CN)

(72) Inventor: Hua Zhu, Shenzhen (CN)

(21) Appl. No.: 18/079,894

(22) Filed: Dec. 13, 2022

(30) Foreign Application Priority Data
Jan. 18, 2022 (CN) 202220124928.0

(51) Int. Cl. A47G 29/08

(52) U.S. Cl. CPC A47G 29/08

(57) ABSTRACT

A finger ring holder includes a protective case and a finger ring on an outer side of the protective case. The outer side of the protective case has a recess. The finger ring and an elastic movable base are installed in the recess. The finger ring has a first end and a second end opposite to the first end. The first end of the finger ring is connected to the elastic movable base through a rotating shaft. The elastic movable base is movably connected to the protective case. An elastic return member is disposed between the elastic movable base and the protective case. The elastic return member is configured to apply a return force to the elastic movable base. The second end of the finger ring is selectively locked to the protective case.

### BACKGROUND OF THE INVENTION

### 1. Field of the Invention

The present invention relates to a holder, and more particularly to a finger ring holder.

### 2. Description of the Prior Art

With the development of science and technology, there are various accessories on the market for electronic devices. Mobile phones are one of the most widely used electronic devices. People are increasingly demanding mobile phone protective case accessories. The mobile phone protective case not only needs to protect the mobile phone from breaking, but also needs to meet the support function of the mobile phone.

Most of the existing finger ring brackets are separated from the protective case. The finger ring bracket is attached to the outer side of the protective case by adhesive. When in use, the user needs to tum the finger ring bracket outward about the rotating shaft, so that the finger ring bracket and the outer side of the protective case form a certain angle, so as to realize the support function of the finger ring bracket for the electronic device. However, in the process of turning the finger ring bracket, the adhesive of the finger ring bracket is easily separated from the protective case due to the action of external force, which affects the normal use of the finger ring bracket.

An improved finger ring bracket is developed accordingly. A rotating shaft is arranged on the outer side of the protective case. The finger ring bracket is connected to the rotating shaft to realize the connection between the finger ring bracket and the protective case. However, because the finger ring bracket has a certain thickness, it is not easy to place the electronic device on a horizontal workbench stably. In addition, since the finger ring bracket is protruded outside the protective case, it is easy to affect the wireless charging of the electronic device. In general, a raised portion is disposed on the back of the protective case. The raised portion has a groove matching the finger ring bracket for receiving and positioning the finger ring bracket. Alternatively, an annular groove is formed on the outer circumference of the raised portion for receiving and positioning the finger ring bracket. In actual use, after the finger ring bracket is unfolded and folded repeatedly, the finger ring bracket cannot be positioned in the recess stably and may be disengaged from the recess. Therefore, some finger ring brackets are designed into a non-closed ring structure having a notch. Both ends of the notch are formed with slightly larger interference portions. In this way, when the finger ring bracket is folded, the interference portions are in interference fit with the recess. Compared with the closed-ring finger ring bracket, it can form a more stable positioning relationship with the recess. However, after the finger ring bracket is unfolded and folded repeatedly, the finger ring bracket cannot be positioned in the recess stably and may be disengaged from the recess due to repeated wear and deformation.

Accordingly, the inventor of the present invention has devoted himself based on his many years of practical experiences to solve these problems.

### SUMMARY OF THE INVENTION

In view of the deficiencies of the prior art, the primary object of the present invention is to provide a finger ring holder. The finger ring holder comprises a protective case. The protective case has a recess. A finger ring and an elastic movable base are installed in the recess. The finger ring is connected to the elastic movable base through a rotating shaft. The elastic movable base is movably connected to the protective case. In a folded state, the elastic movable base enables one end of the finger ring to be locked on the protective case. This solves the problem that the finger ring cannot be positioned in the recess firmly. When it is necessary to unfold the finger ring, the protective case or the elastic movable base is directly pushed. The finger ring holder has a simple structure and is easy to assemble and produce.

In order to achieve the above object, the present invention adopts the following solutions.

A finger ring holder comprises a protective case and a finger ring on an outer side of the protective case. The outer side of the protective case has a recess. The finger ring and an elastic movable base are installed in the recess. The finger ring has a first end and a second end opposite to the first end. The first end of the finger ring is connected to the elastic movable base through a rotating shaft. The elastic movable base is movably connected to the protective case. An elastic return member is disposed between the elastic movable base and the protective case. The elastic return member is configured to apply a return force to the elastic movable base. The second end of the finger ring is selectively locked to the protective case.

Compared with the prior art, the present invention has obvious advantages and beneficial effects. Specifically, in the finger ring holder provided by the present invention, the protective case has the recess. The finger ring and the elastic movable base are installed in the recess. The finger ring is connected to the elastic movable base through the rotating shaft. The elastic movable base is movably connected to the protective case. In a folded state, the elastic movable base enables the second end of the finger ring to be locked on the protective case. This solves the problem that the finger ring cannot be positioned in the recess firmly. When it is necessary to unfold the finger ring, the protective case or the elastic movable base is directly pushed. The finger ring holder has a simple structure and is easy to assemble and produce.

### BRIEF DESCRIPTION OF THE DRAWINGS

FIG. 1 is a perspective view according to an embodiment of the present invention;

FIG. 2 is an exploded view according to the embodiment of the present invention;

FIG. 3 is another exploded view according to the embodiment of the present invention;

FIG. 4 is a perspective view of the elastic movable base according to the embodiment of the present invention; and

FIG. 5 is a cross-sectional view according to the embodiment of the present invention.

### DETAILED DESCRIPTION OF THE PREFERRED EMBODIMENTS

Embodiments of the present invention will now be described, by way of example only, with reference to the accompanying drawings.

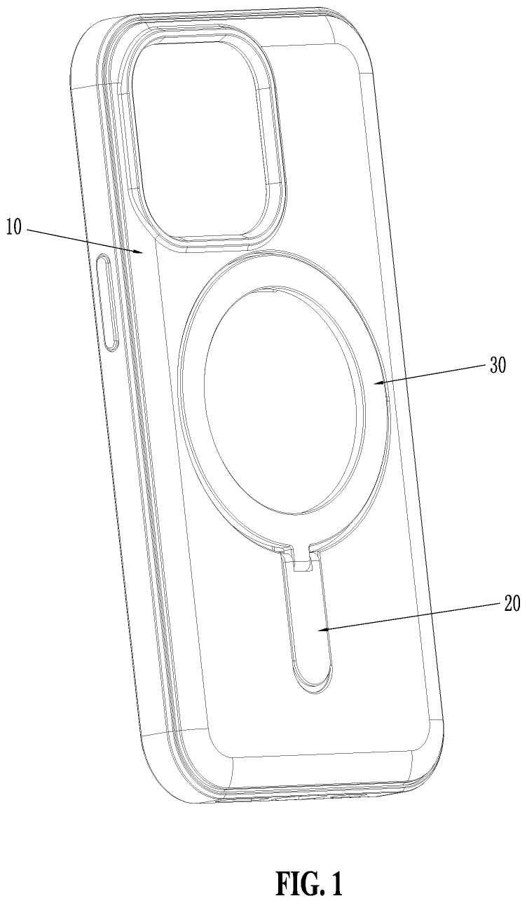

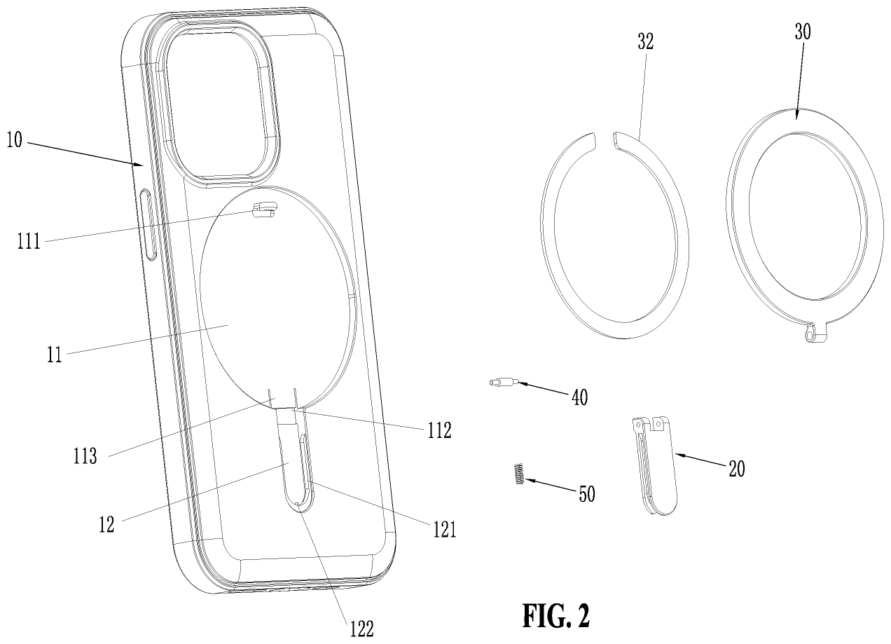

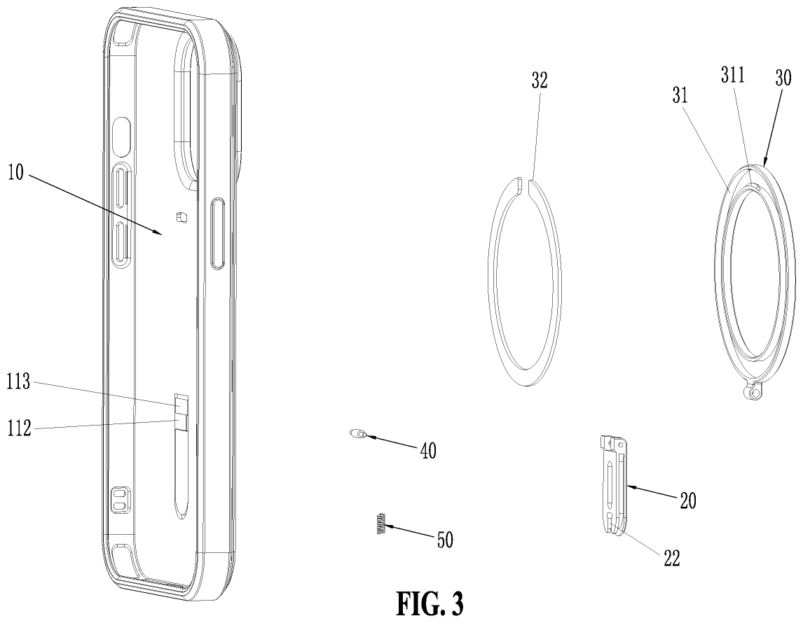

FIGS. 1 to 5 show the specific structure of an embodiment of the present invention. A finger ring holder comprises a protective case 10 and a finger ring 30 on the outer side of the protective case 10. FIG. 1 is a perspective view according to an embodiment of the present invention. FIG. 2 is an exploded view according to the embodiment of the present invention. FIG. 3 is another exploded view according to the embodiment of the present invention. The outer side of the protective case 10 has a recess. The finger ring 30 and an elastic movable base 20 are installed in the recess. The lower end of the finger ring 30 is connected to the elastic movable base 20 through a rotating shaft 40. The elastic movable base 20 is movably connected to the protective case 10. In this embodiment, the recess includes a first recess 11 and a second recess 12 adjacent to and communicating with the first recess 11. The first recess 11 is located above the second recess 12. The finger ring 30 is located in the first recess 11. The elastic movable base 20 is located in the second recess 12. The elastic movable base 20 is movable along the second recess 12. The lower end of the finger ring 30 is connected to the elastic movable base 20 through the rotating shaft 40. An elastic return member 50 is disposed between the second recess 12 and the elastic movable base 20. The elastic return member 50 is configured to apply an upward return force to the elastic movable base 20, so that the elastic movable base 20 can be moved up and down in the second recess 12. The elastic return 50 enables the upper end of the finger ring 30 to be locked on the protective case 10. When the elastic movable base 20 is moved up and down in the second recess 12, the elastic movable base 20 drives the finger ring 30 to move up and down, so that the finger ring 30 can be folded in the recess.

The first recess 11 is formed on the outer side of the protective case 10. In this embodiment, the first recess 11 has a circular shape. A locking hook 111 protrudes outward from the upper end of the first recess 11, so that the finger ring 30 can be locked to the outer side of the protective case 10. Preferably, the inner side of the locking hook 111 has a guide slope. A restricting block 113 is disposed on the lower end of the first recess 11. A U-shaped hollow portion 112 is disposed on the lower end of the first recess 11. The U-shaped hollow portion 112 includes a first hollow portion and two second hollow portions at the left and right sides of the first hollow portion. The first hollow portion is arranged horizontally. The second hollow portions are arranged longitudinally. The restricting block 113 is formed in the area surrounded by the U-shaped hollow portion 112 to restrict the upper end of the elastic movable base 20, so as to prevent the elastic movable base 20 from disengaging from the protective case 10.

The second recess 12 is beside the first recess 11. In this embodiment, the second recess 12 has a U shape. The second recess 12 has a restricting edge 121. The restricting edge 121 has a U shape. The restricting edge 121 is configured to restrict the lower peripheral side of the elastic movable base 20 for restricting the elastic movable base 20 to be moved in the second recess 12. A positioning block 122 is disposed in the second recess 12. The positioning block 122 extends upward from the lower end of the second recess 12 for positioning and installing the elastic return member 50. In addition, the restricting block 113 is located at the upper end of the second recess 12 for restricting the upper end of the elastic movable base 20, so as to prevent the elastic movable base 20 from disengaging from the upper end of the second recess 12.

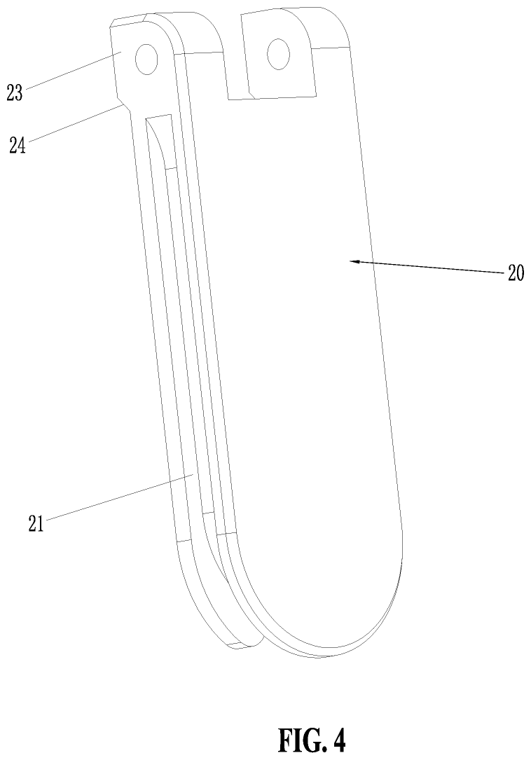

FIG. 4 is a perspective view of the elastic movable base according to the embodiment of the present invention. The elastic movable base 20 is installed in the second recess 12. The elastic movable base 20 is movably connected to the protective case 10. The lower peripheral side of the elastic movable base 20 has a restricting groove 21. The restricting groove 21 is a U-shaped groove. The restricting groove 21 is restricted by the restricting edge 121. Through the cooperation between the restricting edge 121 and the restricting groove 21, the elastic movable base 20 is guided and restricted to move in the second recess 12. The lower end of the elastic movable base 20 is recessed to form an accommodating groove 22. The accommodating groove 22 faces the positioning block 122. In this embodiment, the accommodating groove 22 is located at the upper end of the positioning block 122. The elastic return member 50 is disposed between the accommodating groove 22 and the positioning block 122. Specifically, the upper end of the elastic return member 50 is inserted into the accommodating groove 22, and the lower end of the elastic return member 50 is fitted on the positioning block 122, such that the elastic movable base 20 is moved up and down between the lower end of the restricting block 113 and the lower end of the second recess 12.

The upper end of the elastic movable base 20 protrudes inwardly to form a stop block 23. A guide surface 24 is connected between the lower end surface of the stopper block 23 and the inner surface of the elastic movable base 20. The guide surface 24 is inclined to facilitate the installation of the elastic movable base 20 in the second recess 12. In addition, the rear end of the stop block 23 extends into the first hollow portion of the U-shaped hollow portion 112 for positioning the upper end of the elastic movable base 20.

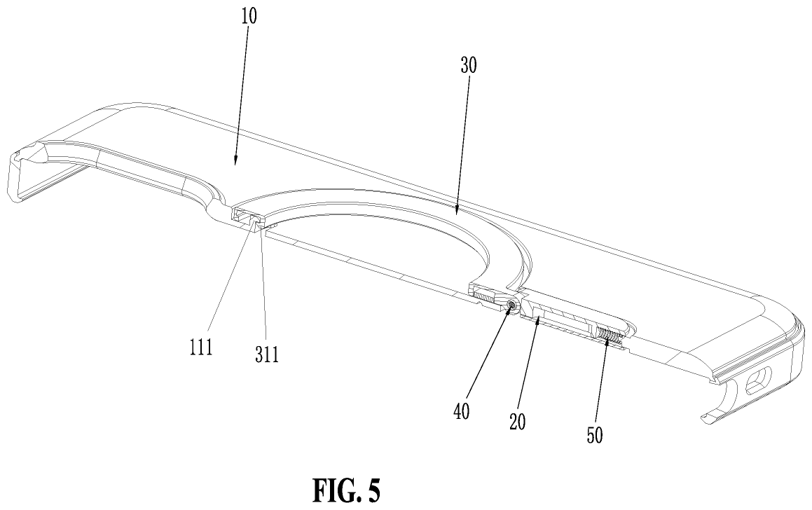

FIG. 5 is a cross-sectional view of the finger ring holder. The upper end of the elastic movable base 20 is connected to the finger ring 30 through the rotating shaft 40. A magnetic member 32 is disposed in the finger ring 30. The magnetic member 32 is an iron sheet or a magnet. The magnetic member 32 is configured to be magnetically attracted with a vehicle charger or a wireless charger, so that the electronic device can be installed and positioned in a vehicle. In this embodiment, the inner side of the finger ring 30 has an annular groove 31. The magnetic member 32 is installed in the annular groove 31. In actual implementation, the magnetic member 32 may be attached to the annular groove 31 by using adhesive, so that the magnetic member 32 can be connected to the finger ring 30 firmly. In addition, a locking block 311 is disposed on the inner side of the finger ring 30. Both the locking hook 111 and the locking block 311 are opposite to the rotating shaft 40. In this embodiment, the rotating shaft 40 is located on the lower end of the finger ring 30. The locking block 311 is located on the upper end of the inner side of the annular groove 31. The locking block 311 is engaged with the lower end of the locking hook 111. The finger ring 30 is rotatable about the rotating shaft 40. When the finger ring 30 is located in the first recess 11, the locking block 311 is engaged with the lower end of the locking hook 111, so that the finger ring 30 is locked to the protective case 10. The finger ring 30 can be folded easily.

Next, the operational of the present invention is described as follows:

When the elastic movable base 20 is moved downward, the restricting groove 21 of the lower peripheral side of the elastic movable base 20 is moved downward along the restricting edge 121 in the second recess 12. The inner wall of the upper end of the accommodating groove 22 in the elastic movable base 20 is pressed against the elastic return member 50. The upper and lower ends of the elastic return member 50 are confined by the accommodating groove 22 and the positioning block 122, respectively. At this time, the locking block 311 of the finger ring 30 is disengaged from the lower end of the locking hook 111, and the finger ring 30 is turned outward about the rotating shaft 40, so as to realize the support function of the finger ring holder.

When the finger ring 30 needs to be folded, the finger ring 30 is rotated inward about the rotating shaft 40 until the finger ring 30 is located in the first recess 11. The finger ring 30 is released, and the elastic return member 50 is returned. Under the action of the elastic return member 50, the elastic movable base 20 is moved upward along the restricting edge 121. The elastic movable base 20 drives the finger ring 30 to move upward. The locking block 311 of the finger ring 30 is engaged with the lower end of the locking hook 111, so as to lock the finger ring 30 on the protective case 10. It should be noted that, if the locking block 311 and the locking hook 111 are not provided, the elastic return member 50 can exert a return force to the elastic movable base 20, so that the other end of the finger ring 30 is tightly pressed in the recess. In this way, the positioning stability of the finger ring 30 to be folded relative to the protective case 10 can be improved, so as to prevent the finger ring 30 from being disengaged from the recess.

What is claimed is:

1. A finger ring holder, comprising a protective case and a finger ring on an outer side of the protective case, the outer side of the protective case having a recess, the finger ring and an elastic movable base being installed in the recess, the finger ring having a first end and a second end opposite to the first end, the first end of the finger ring being connected to the elastic movable base through a rotating shaft, the elastic movable base being movably connected to the protective case, an elastic return member being disposed between the elastic movable base and the protective case, the elastic return member being configured to apply a return force to the elastic movable base, the second end of the finger ring being selectively locked to the protective case.

2. The finger ring holder as claimed in claim 1, wherein a locking hook protrudes outward from an inner surface of the first recess, a locking block is disposed on an inner side of the second end of the finger ring, the locking hook and the locking block are opposite to the rotating shaft, and the locking block is selectively engaged with a lower end of the locking hook.

3. The finger ring holder as claimed in claim 1, wherein the recess includes a first recess and a second recess adjacent to the first recess, the finger ring is located in the first recess, the elastic movable base is located in the second recess, one end of the second recess communicates with the first recess, a first end of the elastic return member acts on another end of the second recess, a second end of the elastic return member acts on the elastic movable base, and the elastic movable base is movable along the second recess.

4. The finger ring holder as claimed in claim 3, wherein a positioning block is disposed in the second recess, the elastic movable base has an accommodating groove, the accommodating groove faces the positioning block, the first end of the elastic return member is fitted on the positioning block, and the second end of the elastic return member is inserted into the accommodating groove.

5. The finger ring holder as claimed in claim 3, wherein a peripheral side of the elastic movable base has a restricting groove, a restricting edge is disposed on a peripheral side of the second recess, and the restricting edge extends into the restricting groove.

6. The finger ring holder as claimed in claim 4, wherein a peripheral side of the elastic movable base has a restricting groove, a restricting edge is disposed on a peripheral side of the second recess, and the restricting edge extends into the restricting groove.

7. The finger ring holder as claimed in claim 1, wherein a magnetic member is disposed in the finger ring, and the magnetic member is one of an iron sheet and a magnet.
